(19) United States
(12) Patent Application Publication
(10) Pub. No.: US 2004/0129358 A1
(43) Pub. Date: Jul. 8, 2004

(54) Pneumatic tire

(75) Inventors: Helmut Ernst, Burgwald-Bottendorf (DE); Harald Bornmann, Haina (DE); Jurgen Becker, Diemelsee (DE)

Correspondence Address: GREENBLUM & BERNSTEIN, P.L.C., 1950 ROLAND CLARKE PLACE, RESTON, VA, 20191, US

(73) Assignee: Continental Aktiengesellschaft, Hannover (DE)

(21) Appl. No.: 10/704,603

(22) Filed: Nov. 12, 2003

(30) Foreign Application Priority Data
Nov. 14, 2002 (EP) 02025378.7

(51) Int. Cl. B60C 1/00; B60C 5/00; B60C 11/00; B60C 13/00; B29D 30/00

(52) U.S. Cl. 152/209.5; 152/209.11; 152/525; 152/450; 156/123

(57) ABSTRACT

Pneumatic tire, particularly a two-wheeler pneumatic tire, such as a bicycle tire, which includes at least one rubberized casing that is anchored in beads by wrapping bead cores. A tread is provided. An outer covering has a layer thickness of less than or equal to 0.5 mm. The outer covering has a high tear resistance and extends at least over the tread.

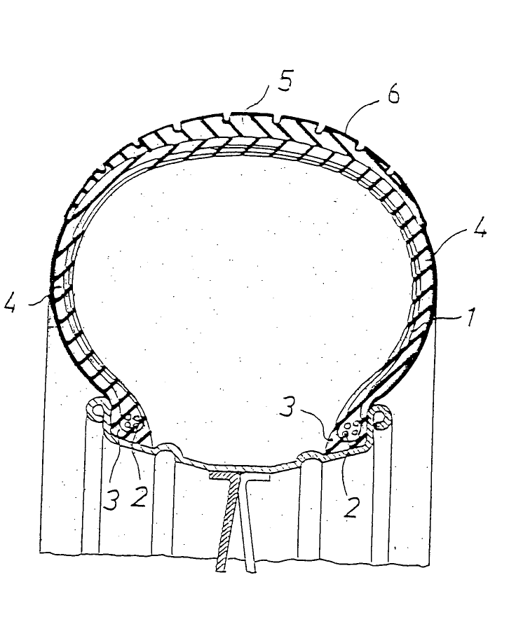

### CROSS-REFERENCE TO RELATED APPLICATIONS

The present application claims priority under 35 U.S.C. §119 of European Patent Application No. 02025378.7, filed on Nov. 14, 2002, the disclosure of which is expressly incorporated by reference herein in its entirety.

### BACKGROUND OF THE INVENTION

1. Field of the Invention

The invention relates to a pneumatic tire, and particularly to a two-wheeler pneumatic tire, and even more particularly a bicycle pneumatic tire. The tire includes at least one rubberized casing that is anchored in the beads by wrapping the bead cores, a tread made of rubber, and possibly sidewall rubber coverings.

2. Discussion of Background Information

Two-wheeler pneumatic tires of the kind mentioned at the outset with sidewall rubber coverings are known, e.g., from EP-A-0 117 904, the disclosure of which is incorporated by reference herein in its entirety. There are also bicycle tires available on the market that, for reasons of weight, do not have a sidewall rubber covering and for which the rubberized casing forms the sidewall.

For the production of two-wheeler pneumatic tires, highly variable rubber mixtures are used, with the handling characteristics of the tire depending to a great extent on the rubber composition of the tread. Thus, the tire should have little abrasion and little rolling resistance, as well as very good road grip on wet and dry surfaces. In addition, the tire should have high durability. The durability is determined not only by abrasion, but also aging cracks that arise through the influence of ozone, heat and UV radiation, which contribute to an earlier failure of the tire. Depending on production and use, these aging cracks appear with bicycle tires especially on the base of the tread groove as well as on the sidewalls (flank area), since the greatest flexing work appears there. In the tread lugs, however, cracks generally hardly ever appear.

In order to do justice to all the desired characteristics, two-wheeler pneumatic tires are provided in the tread area with mixtures that offer a compromise between tear resistance and handling characteristics such as rolling resistance and wet-and-dry road grip. This is because mixtures that are particularly good in rolling resistance and in wet-and dry road grip do not as a rule have good tear resistance, and vice versa.

From DE 196 53 371 C2, the disclosure of which is incorporated by reference herein in its entirety, bicycle tires with light-colored, i.e., not black, treads are known which have little abrasion, good road grip on wet and dry pavement and at the same time an excellent aging resistance. The tread consists of a single mixture that contains 20 to 50 phr solution-polymerized styrene-butadiene copolymer, 20 to 40 phr ethylene propylene diene rubber and/or butylene styrene copolymer, 10 to 60 phr natural rubber, 30 to 70 phr silicic acid and 1.9 to 4.4 phr activator, as well as other customary fillers and additives. Even this mixture—although at a very high level—can only offer a compromise between tear resistance and handling characteristics.

To avoid tears in the sidewall area of bicycle tires which are caused by brittleness due to softener diffusion, it is suggested in JP-A-1111503, the disclosure of which is incorporated by reference herein in its entirety, that the tread consist of a middle area and side areas, whereby varying rubber mixtures with varying softener contents are used for the middle area and for the side areas.

### SUMMARY OF THE INVENTION

The present invention provides for two-wheeler pneumatic tires, especially bicycle pneumatic tires, which have an especially high tear resistance and, associated with that, high durability. On the other hand, such tires, do not at the same time, have losses in the handling characteristics, such as rolling resistance and wet-and-dry road grip.

The present invention is directed to a pneumatic tire, comprising a rubberized casing that is anchored in beads by wrapping bead cores; a tread; and an outer covering having a layer thickness of less than or equal to 0.5 mm, wherein the outer covering has a high tear resistance and extends at least over the tread.

The present invention is also directed to a method of making a pneumatic tire having beads, the method comprising arranging a tread on a rubberized casing which is anchored in the beads; applying an outer covering having a layer thickness of less than or equal to 0.5 mm, wherein the outer covering has a high tear resistance and extends at least over the tread.

The present invention is also directed to a bicycle tire having beads, comprising a rubberized casing that is anchored in the beads; a rubber tread; an outer covering that covers at least the tread; and the outer covering having a layer thickness of less than or equal to 0.5 mm, wherein the outer covering is made from a vulcanized rubber mixture which contains 30 to 60 phr ethylene propylene diene rubber (EPDM); 40 to 70 phr natural rubber (NR); 0 to 20 phr polybutadiene (BR); and additives.

The pneumatic tire can be a two-wheeler tire, preferably a bicycle tire.

The tread can be composed of rubber.

The tire can further comprise sidewall rubber coverings.

The outer covering can comprise a rubber covering.

The outer covering can extend from one of the beads over sidewalls and over the tread to another of the beads.

The outer covering can have a layer thickness of between 0.15 mm and 0.3 mm.

The outer covering can comprise a vulcanized rubber mixture which contains 30 to 60 phr ethylene propylene diene rubber (EPDM); 40 to 70 phr natural rubber (NR); 0 to 20 phr polybutadiene (BR); and additives.

The vulcanized rubber mixture can contain one of non-discoloring and slightly discoloring antioxidants.

The vulcanized rubber mixture can contain no antioxidants.

The tread can comprise a vulcanized rubber mixture which contains between 70 phr to 100 phr natural rubber and 0 phr to 30 phr polybutadiene rubber.

The present invention also provides methods of making bicycle tires comprising forming the bicycle tire with a tread and a rubberized casing which is anchored in beads; and applying the outer covering at least onto the tread.

Exemplary embodiments and advantages of the present invention may be ascertained by reviewing the present disclosure and the accompanying drawing.

### BRIEF DESCRIPTION OF THE DRAWING

The present invention is further described in the detailed description which follows, in reference to the noted drawing by way of a non-limiting exemplary embodiment of the present invention, and wherein:

The sole FIGURE schematically shows a bicycle tire in a radial partial section, as manufactured.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawing making apparent to those skilled in the art how the several forms of the present invention may be embodied in practice.

The invention provides for a tire which is manufactured with a covering on the outside, in particular a rubber covering with a layer thickness of ≦0.5 mm, and which has a high tear resistance. The covering can extend at least over the tread.

The tire accordingly has two different rubber mixtures in the tread area. While riding, the thin rubber covering abrades after a short time only on the tread lugs and the conventional tread mixture lying underneath it thereby again comes into contact with the pavement.

The basic concept of the invention is that the areas of the tire that are exposed to especially high stresses by flexing work (base of the tread groove) and which therefore have a tendency to form cracks after aging under the influence of ozone, heat and UV radiation are protected by the presence of a thin, especially tear-resistant rubber covering during the life of the tire, whereas the surfaces of the tread coming into contact with the pavement have a conventional tread mixture that can be optimized with regard to its characteristics such as rolling resistance and wet-and-dry grip, without it being necessary at the same time to pay attention to high tear resistance. Overall, the two-wheeler pneumatic tire according to the invention combines the characteristics of a tear-resistant mixture as surface covering with the positive characteristics of a tread mixture (road grip, rolling resistance).

The covering can be a covering made of rubber or of a rubber-like material such as, e.g., a thermoplastic elastomer or thermoplastic material. Rubber coverings are preferred since they can easily be firmly bonded with the mixture coverings underneath them, e.g., during vulcanization.

According to an advantageous further development of the invention, the covering extends from the beads over the sidewall rubber coverings of the entire sidewalls and the tread. In this manner the entire sidewalls, which are particularly exposed to UV light and are subject to the flexing work, are also protected from cracks by the covering. This further development, in addition, offers the advantage that such a tire can be easily manufactured. During the manufacture of the actual tread and sidewall blanks, which are produced by way of extrusion, a thin rubber mixture covering, for example, which forms the thin surface covering after vulcanization, can be double-applied. However, the covering can also be applied by spraying or spreading of, e.g., a solution of the rubber mixture in organic solvent.

However, it is also possible for the exterior covering to extend only over the tread and especially the stressed, radially exterior parts of the sidewalls.

The covering of the outside preferably has a layer thickness of between 0.15 mm and 0.3 mm. It has proven that the best protection from cracks is attained with these layer thicknesses without negatively influencing other tire characteristics in the process. These thicknesses can be easily produced in terms of process engineering.

If the covering on the outside is a rubber covering, this rubber covering can be based on various rubber mixtures that have high tear resistance as vulcanized materials. Thus, the rubber mixture can, for example, contain as rubbers ethylene propylene diene rubber (EPDM), or copolymers of isobutylene and para-methyl styrene, which are possibly halogenated (e.g., EXXPRO® by Exxon Chemical). High tear resistance is a distinguishing feature of these rubber types.

Preferably, the exterior rubber covering is based on a vulcanized rubber mixture that contains 30 to 60 phr ethylene propylene diene rubber (EPDM), 40 to 70 phr natural rubber (NR), 0 to 20 phr polybutadiene (BR), and other customary additives. The portions of the rubbers add up to one hundred in the mixture. Instead of the EPDM, a copolymer of isobutylene and para-methyl styrene, which is possibly halogenated, or a blend of EPDM and the copolymer can be used in this mixture.

The indication “phr” (parts per hundred parts of rubber by weight) used in this document is the customary unit of quantity in the rubber industry for mixture formulas. The proportioning of the parts by weight of the individual substances is thereby always taken in relation to 100 parts by weight of the total mass of all rubbers present in the mixture.

Such rubber mixtures with a large proportion of EPDM are distinguished by high tear resistance when there is ozone and UV light aging. If less than approximately 30 phr EPDM is used, the protection against cracks is no longer guaranteed to the full extent. With clearly more than approximately 60 phr, the dynamic characteristics such as elasticity, tear-growth resistance and tensile value are reduced. The miscibility also becomes problematic with increasing quantities over approximately 60 phr EPDM. Since EPDM is a relatively expensive synthetic rubber, the use as thin surface covering offers the advantage that only small quantities of the expensive rubber are used in the mass product and the price of the tire can by that means be kept low.

High tear resistance according to the present invention permits the extended use of the tire without showing tears as compared to conventional tires. For example, the outer layer features a high tear resistance on the tire in combination with other materials included in the tire. As noted in the examples herein which simulate typical use, a conventional tire already shows tears after 48 hours (approximately 2,500 km) whereas the tire according to the present invention still does not show any tears after 100 hours (approximately 5,000 km). Thus, the tires according to the present invention show a tear resistance of more than 2,500 km during simulations such as disclosed in the present application.

Moreover, it is preferable that tires according to the present invention do not exhibit tears when exposed to UV radiation for 72 hours, which is in contrast to conventional tires.

When layer 6 is a rubber layer, the rubber in the form of a specimen preferably does not exhibit any tears according to DIN 53509 after 48 hours at 200 ppm ozone and 20% elongation. The specimen should exhibit a tear level of 0 when measuring the ozone tear resistance according to DIN 53509, which pertains to testing rubber and elastomers—determining the resistance to tear formation during ozone influence.

The rubber mixture can contain customary additives in customary parts by weight. These additives include, for example, fillers (e.g., carbon black, silicic acid), color pigments, antioxidants, processing aids, softeners, cross-linking agents (e.g., sulfur or peroxides) and vulcanization accelerators. The production of the rubber mixture according to invention takes place in the conventional way in one or more mixing stages.

According to an advantageous further development of the invention, the rubber mixture for the rubber covering contains non-discoloring or slightly discoloring antioxidants or no antioxidant at all. Non-discoloring or slightly discoloring antioxidants such as, e.g., 2,2-methylene-bis (4-methyl-6-tert.butylphenol) (BPH), substituted phenol (DS), styrenated phenol (SPH) or 2,2,4-trimethyl-1,2-dihydroquinoline (TMQ) are as a rule less effective in protecting against cracks from aging due to ozone, UV light and heat in comparison to discoloring antioxidants (e.g., aromatic amines). According to one embodiment of the invention, the mixture has a large proportion of EPDM, no antioxidants are required, or non-discoloring or slightly discoloring antioxidants suffice to guarantee sufficient tear resistance of the rubber covering.

The use of non-discoloring or slightly discoloring antioxidants or no antioxidant at all offers additionally the advantage that the rubber covering can be embodied in color or provided with colored applications, e.g., labels or reflecting strips, without unsightly discolorations appearing due to discoloring antioxidants. In this way, the desired visual characteristics of the two-wheeler pneumatic tire are taken into account. Especially in the case of bicycle tires, long-lasting visually attractive embodiments that in addition should have excellent handling characteristics are in demand with customers.

The rubber covering can have the same color as the tread mixture underneath it. However, it is also possible for rubber covering and tread mixture to differ in color. If the rubber cover is embodied in a color other than the tread mixture underneath it, it becomes visible to the user when, after a long life, the rubber covering has the slightest cracks, since the tread mixture then shows through.

It is especially advantageous if the tread of the two-wheeler pneumatic tire is based on a vulcanized rubber mixture that contains only natural rubber and/or polybutadiene as rubbers. After vulcanization, mixtures on the basis of these rubbers have an especially good road grip on wet and dry pavement, at the same time with low rolling resistance. In addition, these rubber types are inexpensive.

Also with the rubber mixture for the tread the antioxidants can be omitted which, with regard to aging due to ozone, UV light and heat, are more active but are discoloring, since the covering over the tread takes on the protection against cracks caused by such aging.

The two-wheeler pneumatic tire according to the invention can be produced in accordance with procedures familiar to the one skilled in the art, in which the covering on the outside can be applied before or after vulcanization by the most varied known application and coating procedures.

The invention also provides for a two-wheeler pneumatic tire that comprises at least one rubberized casing that is anchored in beads by wrapping bead cores, a tread, and a outer covering having a layer thickness of less than or equal to 0.5 mm, wherein the outer covering has a high tear resistance and extends at least over the tread.

The two-wheeler pneumatic tire may be a bicycle tire. The tread may be made of rubber. The tire may further comprise rubber sidewall coverings. The outer covering may be a rubber covering. The outer covering may extend from one of the beads over sidewalls and over the tread to another of the beads. The outer covering may have a layer thickness of between 0.15 mm and 0.3 mm.

The outer covering may comprise a vulcanized rubber mixture which contains: 30 to 60 phr ethylene propylene diene rubber (EPDM); 40 to 70 phr natural rubber (NR); 0 to 20 phr polybutadiene (BR); and additives. The additives may be customary additives. The vulcanized rubber mixture may contain one of non-discoloring and slightly discoloring antioxidants. The vulcanized rubber mixture may lack non-discoloring or slightly discoloring antioxidants.

The tread may comprise a vulcanized rubber mixture which contains between 70 phr to 100 phr natural rubber and 0 phr to 30 phr polybutadiene rubber.

The invention also provides for a method of making a pneumatic tire having beads, wherein the method comprises arranging a tread on a rubberized casing which is anchored in the beads, and applying an outer covering having a layer thickness of less than or equal to 0.5 mm, wherein the outer covering has a high tear resistance and extends at least over the tread.

The pneumatic tire may be a bicycle tire. The tread may be made of rubber. The method may further comprise applying rubber coverings to the sidewalls. The outer covering may be a rubber covering. The outer covering may extend from one of the beads over sidewalls and over the tread to another of the beads. The outer covering may have a layer thickness of between 0.15 mm and 0.3 mm.

The method may further comprise forming the outer covering from a vulcanized rubber mixture which contains: 30 to 60 phr ethylene propylene diene rubber (EPDM); 40 to 70 phr natural rubber (NR); 0 to 20 phr polybutadiene (BR); and additives.

The additives may be customary additives. The vulcanized rubber mixture may contain one of non-discoloring and slightly discoloring antioxidants, or no antioxidant at all. The vulcanized rubber mixture may lack non-discoloring, slightly discoloring antioxidants or discoloring antioxidants. The tread may comprise a vulcanized rubber mixture which contains between 70 phr to 100 phr natural rubber and 0 phr to 30 phr polybutadiene rubber.

The invention also provides for a bicycle tire having beads, wherein the tire comprises at least one rubberized casing that is anchored in the beads, a rubber tread and an outer covering that covers at least the tread. The outer covering has a layer thickness of less than or equal to 0.5 mm. The outer covering is made from a vulcanized rubber mixture which contains 30 to 60 phr ethylene propylene diene rubber (EPDM), 40 to 70 phr natural rubber (NR), 0 to 20 phr polybutadiene (BR), and additives.

The invention also provides for a method of making the bicycle tire described above, wherein the method comprises forming the bicycle tire with a tread and a rubberized casing which is anchored in beads, and applying the outer covering at least onto the tread.

The bicycle tire according to the FIGURE has a diagonal casing 1 made of two fabric layers which are anchored in the tire beads 3 by wrapping wire bead cores 2. Outside on the side, there is a sidewall rubber covering 4 on the tire sidewalls. The rubber covering can extend in one piece from one bead 3 to another bead 3. Further, the tire has a tread 5 made of rubber. The tire, as manufactured, has a rubber covering 6 that extends on the outside of the tire from the beads 3 over the sidewall rubber covering 4 and the tread 5. The rubber covering 6 has a layer thickness of less than 0.5 mm and has high tear resistance. While riding, the rubber covering 6 is quickly abraded radially outside on the tread lugs by contact with the surface, but the bases of the tread groove which are especially susceptible to cracks and the sidewalls remain protected by the rubber covering 6.

Appropriate rubber mixtures with good tear resistance for the rubber covering 6 and with good rolling resistance, and good wet-and-dry road grip for the tread 5, are listed below in Table 1.

TABLE 1

| | |
|---|---|
| Mixture for | Mixture for |
| rubber covering (6) | tread (5) |

| | | | |
|---|---|---|---|
| 45 | phr NR | 80 | phr NR |
| 55 | phr EPDM | 20 | phr BR |
| 6.5 | phr processing aids | 6.5 | phr processing aids |
| 2 | phr antioxidants | 2 | phr antioxidants |
| | (slightly discoloring) | | (slightly discoloring) |
| 50 | phr fillers | 65 | phr fillers |
| 9 | phr softeners | 10 | phr softeners |
| 2 | phr sulfur | 2.3 | phr sulfur |
| 1.95 | phr accelerators | 1.8 | phr accelerators |

Bicycle tires according to the invention were produced from the mixture for the exterior rubber covering according to Table 1 and a tread with a mixture according to Table 1, in the production of which a 0.5 mm thick covering of the mixture for the exterior covering was double-applied to the unvulcanized tread. After vulcanization in the vulcanization press, the finished tire had an exterior covering that had a layer thickness of between approximately 0.3 mm to approximately 0.5 mm. Bicycle tires with the same tread mixture were used as comparison, but without the exterior covering according to invention. In tests, on an outside test bench (dynamic tear run), the comparison tires without exterior covering exhibited cracks on the sides and in the base of the tread groove after 48 hrs. (approx. 2500 km). The tires according to the invention with the exterior covering were still free of cracks after 100 hrs. (approx. 5000 km).

In tests under an UV lamp (static), tire sections without additional exterior covering showed substantial cracks after 72 hrs., while the tires according to the invention were still free of cracks.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A pneumatic tire, comprising:
a rubberized casing that is anchored in beads by wrapping bead cores;
a tread; and
an outer covering having a layer thickness of less than or equal to 0.5 mm,
wherein the outer covering has a high tear resistance and extends at least over the tread.

2. The tire of claim 1, wherein the pneumatic tire is a two-wheeler tire.

3. The tire of claim 1, wherein the pneumatic tire is a bicycle tire.

4. The tire of claim 1, wherein the tread is composed of rubber.

5. The tire of claim 1, further comprising sidewall rubber coverings.

6. The tire of claim 1, wherein the outer covering comprises a rubber covering.

7. The tire of claim 1, wherein the outer covering extends from one of the beads over sidewalls and over the tread to another of the beads.

8. The tire of claim 1, wherein the outer covering has a layer thickness of between 0.15 mm and 0.3 mm.

9. The tire of claim 1, wherein the outer covering comprises a vulcanized rubber mixture which contains:
30 to 60 phr ethylene propylene diene rubber (EPDM);
40 to 70 phr natural rubber (NR);
0 to 20 phr polybutadiene (BR); and
additives.

10. The tire of claim 9, wherein the vulcanized rubber mixture contains one of non-discoloring and slightly discoloring antioxidants.

11. The tire of claim 9, wherein the vulcanized rubber mixture does not contain antioxidants.

12. The tire of claim 1, wherein the tread comprises a vulcanized rubber mixture which contains between 70 phr to 100 phr natural rubber and 0 phr to 30 phr polybutadiene rubber.

13. A method of making a pneumatic tire having beads, the method comprising:
arranging a tread on a rubberized casing which is anchored in the beads;
applying an outer covering having a layer thickness of less than or equal to 0.5 mm,
wherein the outer covering has a high tear resistance and extends at least over the tread.

14. The method of claim 13, wherein the pneumatic tire is a bicycle tire.

15. The method of claim 13, wherein the tread is composed of rubber.

16. The method of claim 13, further comprising applying rubber coverings to the sidewalls.

17. The method of claim 13, wherein the outer covering comprises a rubber covering.

18. The method of claim 13, wherein the outer covering extends from one of the beads over sidewalls and over the tread to another of the beads.

19. The method of claim 13, wherein the outer covering has a layer thickness of between 0.15 mm and 0.3 mm.

20. The method of claim 13, further comprising forming the outer covering from a vulcanized rubber mixture which contains:
30 to 60 phr ethylene propylene diene rubber (EPDM);
40 to 70 phr natural rubber (NR);
0 to 20 phr polybutadiene (BR); and
additives.

21. The method of claim 20, wherein the vulcanized rubber mixture contains one of non-discoloring and slightly discoloring antioxidants.

22. The method of claim 20, wherein the vulcanized rubber mixture does not contain antioxidants.

23. The method of claim 13, wherein the tread comprises a vulcanized rubber mixture which contains between 70 phr to 160 phr natural rubber and 0 phr to 30 phr polybutadiene rubber.

24. A bicycle tire having beads, comprising:
a rubberized casing that is anchored in the beads;
a rubber tread;
an outer covering that covers at least the tread; and
the outer covering having a layer thickness of less than or equal to 0.5 mm,
wherein the outer covering is made from a vulcanized rubber mixture which contains:
30 to 60 phr ethylene propylene diene rubber (EPDM);
40 to 70 phr natural rubber (NR);
0 to 20 phr polybutadiene (BR); and
additives.

25. A method of making the bicycle tire of claim 24, the method comprising:
forming the bicycle tire with a tread and a rubberized casing which is anchored in beads; and
applying the outer covering at least onto the tread.
